(19) United States
(12) Patent Application Publication
(10) Pub. No.: US 2022/0152875 A1
(43) Pub. Date: May 19, 2022

(54) LOW PRESSURE EXTRUDER, EQUIPMENT AND METHOD FOR MANUFACTURING A LOW-DENSITY PLASTIC COMPOSITE MATERIAL, AND THE LOW-DENSITY PLASTIC COMPOSITE MATERIAL

(71) Applicant: Minh Tam Do, Ho Chi Minh (VN)

(72) Inventor: Minh Tam Do, Ho Chi Minh (VN)

(21) Appl. No.: 17/528,283

(22) Filed: Nov. 17, 2021

(30) Foreign Application Priority Data
Nov. 17, 2020 (VN) 1-2020-06645

(51) Int. Cl. B29B 7/42; B29C 48/51; B29B 7/82

(52) U.S. Cl. CPC B29B 7/429; B29B 7/82; B29C 48/51

(57) ABSTRACT

The invention relates to a low pressure extruder (3) for manufacturing a low density plastic composite material, characterized in that, the volume between the cylinder and the screw per unit length is not decreased along the direction from the hopper to the die in order that the mixture is extruded at low pressure in the melted state out of the cylinder of the extruder; the die is heated by the heater to maintain the melted state of the material in order not to create resistance to the flow in the process of pushing the material mixture out of the cylinder of the extruder. Furthermore, the present invention provides a method and equipment for manufacturing this material.

### TECHNICAL FIELD

The present invention relates to a low-density plastic composite material such as the WPC (wood plastic composite) material, and an extruder, equipment and method for manufacturing the material.

### BACKGROUND ART

As we already know, composite materials consist of matrix materials and reinforcements, e.g., WPC. The reinforcements, which may also be referred to as reinforcing materials, ensures that the composite material has the required mechanical properties. Meanwhile the matrix materials ensures that the reinforcement constituents of the composite are bound together in order to form monolith and unity for the composite. Typical matrix materials include plastics (also called resins), metal, mineral, ceramic; wherein the plastic matrix comprises 2 main types, which include thermosetting plastics such as phenolic resin, furan resin, amine plastics, epoxy resin and thermosoftening plastics, such as PVC, polyethylene, polypropylene, polyamide, etc.

WPC has been known as a composite material which includes compatible ratio of the wood as reinforcing material and thermoplastic as matrix material. WPC can be produced by various methods. Currently, the most popular technology is extrusion, using a screw extruder, wherein the screw mixes the wood flour, thermoplastics and additives into a mixture in melted state within the cylinder of the extruder and continuously extrudes this mixture through an opening with constant cross-section (extrusion die) which cools and shapes the final products. To have the mixture evenly mixed and plasticized within the cylinder, and to increase tightness of the structure and sparkle of the product, the screw of the extruder always includes the conventional structures comprising:
constant screw pitch, descending groove depth;
descending screw pitch, constant groove depth;
descending screw pitch, descending groove depth;
constant screw pitch, constant groove depth, the last region having barrier fights.

In general, the applied method includes changing the groove depth, changing the screw pitch, or a combination of both to form ascending high pressure during the mixing process and extruding the mixture within the cylinder, thereby reaching a compression rate of 1.5-5 of the WPC material mixture in the melted state.

Another factor contributing to the increase of the mixture pressure in melted state is the process of cooling the mixture to the curing temperature and the shaping of the mixture within the extrusion die. This process forms a considerable resistance to the flow during the extrusion of the mixture out of the extruder cylinder, increasing the pressure of the mixture.

Hence, as discussed above, the production of WPC by screw extruder in the prior art eventually forms high pressure for the material mixture in melted state, which may be up to 300-500 kg/cm². As a result, wood constituent in the conventional WPC mixture is compressed and its density can increase from 600-800 kg/m³ to 1100-1500 kg/m³, leading to an increase of WPC density up to 1100-1400 kg/m3, eventually leading to an increase of the final product weight. This in turn leads to an increase of the WPC prices and, in some cases, difficulty for shipping or works in complicated conditions such as construction sites or works at height.

In order to reduce density of the WPC material, the prior art applies the foaming method using foaming agents and particular die structure to form empty air bubbles inside of the WPC material block, but this method can only be applied for PVC and does not effectively work for other thermoplastics. This method still uses the screw extruder with features of continuously creating high pressure to the material mixture in melted state before being cooled and shaped in the shaping mold as discussed above.

### SUMMARY OF THE INVENTION

The present invention has been proposed to solve the aforementioned problems, particularly to provide a plastic low density composite material, with constant ratio of the reinforcing materials and plastic compared to the equivalents, such as WPC equivalents.

For the aforementioned object and others, the invention provides a plastic low density composite material and a method for manufacturing this material which is referred to as the low-pressure extrusion method. Unlike materials of the prior art, e.g. conventional WPC, the plastic low density composite material is produced by the method wherein the wood (pulverized or ground with larger size depending on the required characteristics of the product), thermoplastics and additives are mixed in melted state within the cylinder of the extruder with screw having composition different from the conventional extruder in order not to form high pressure for the material mixture extruded out of the extruder via an extrusion die which has the temperature sufficient to maintain the melted state of the material in order not to form resistance to the flow in the process of extruding the material mixture out of the cylinder of the extruder, after which being cooled and shaped by the structures that allow easy release of the redundant material in order not to form high pressure in this process.

The material according to present disclosure is manufactured by the low-pressure extruder, which is used to produce the low-density plastic composite material, which comprises:
a cylinder;
a hopper to supply the constituents of the composite material into the cylinder;
a screw to mix the constituents of the composite material into a mixture in melted state within the cylinder of the extruder and to continuously extrude this mixture;
a die to release the mixture out of the cylinder;
a heater;
characterized by,
   the volume between the cylinder and the screw per unit length is not decreased along the direction from the hopper to the die in order that the mixture is extruded at low pressure in the melted state out of the cylinder of the extruder;
   the heater configured to heat the die to maintain the melted state of the mixture in order not to form resistance to the flow in the process of pushing the material mixture out of the cylinder of the extruder.

That is, the material mixture will be extruded with the pressure not as high as that of the prior art (which may be referred to as low pressure) due to the structure of the screw and the heater. The wood constituent in the mixture according to this method for manufacturing WPC is compressed under a lower pressure than that of conventional extrusion process, thereby leading to low density for the WPC material sheet.

In an aspect, the invention provides equipment including the above low-pressure extruder.

In another aspect, the invention also provides method for manufacturing the low density plastic composite material wherein the mixture is continuously extruded in melted state under a low pressure through extrusion die due to the volume between the cylinder and the screw per unit length not being reduced, thus not creating high pressure; and the die is heated to maintain the melted state of the material in order not to form resistance to the flow in the process of extruding the material mixture out of the cylinder of the extruder.

Furthermore, to enhance mechanical properties and bonding of the WPC constituents, the invention proposes producing the spine structure bound with thermoplastics (or other matrix materials) from the coating into the center of or throughout the WPC block.

### BRIEF DESCRIPTION OF THE DRAWINGS

Hereinafter, the present invention will be described in detail with reference to the accompanying drawings. The contents described herein are for illustrative purposes only and are not intended to limit the scope of the present disclosure, wherein:

FIG. 1 is an enlarged schematic view illustrating the WPC materials using wood-based reinforcing materials sized 2 to 3 mm in accordance with well-known prior art.

FIG. 2 is an enlarged schematic view illustrating the WPC materials using wood-based reinforcing materials sized 2 to 3 mm manufactured by the low-pressure extrusion method according to present disclosure with wood-plastic ratio similar to that of the WPC materials in FIG. 1.

FIG. 3 is a schematic view illustrating method for manufacturing the plastic low density composite materials using screw extruder with constant screw pitch, constant groove depth and heated extrusion die, then being cooled and shaped by the shaping rollers.

FIG. 4 is a schematic view illustrating screw extruder with ascending screw pitch, constant groove depth.

FIG. 5 is a schematic view illustrating screw extruder with constant screw pitch, ascending groove depth.

FIG. 6 is a schematic view illustrating screw extruder with ascending screw pitch, ascending groove depth.

FIG. 7 is a schematic view illustrating manufacturing method of products using the low-density WPC materials in accordance with an embodiment;

FIG. 8 is a schematic view illustrating the WPC materials with spine structure bound with thermoplastics (or other matrix materials) from the coating into the center of the WPC block.

### DETAILED DESCRIPTION

Hereinafter, the present invention will be described in detail with reference to the accompanying drawings. Like reference numerals in the drawings are used to identify like or similar components.

The term WPC is used in the description, but it should be understood that, the present disclosure encompasses various embodiments wherein reinforcing materials are not wood, WPC is only an embodiment of the present disclosure.

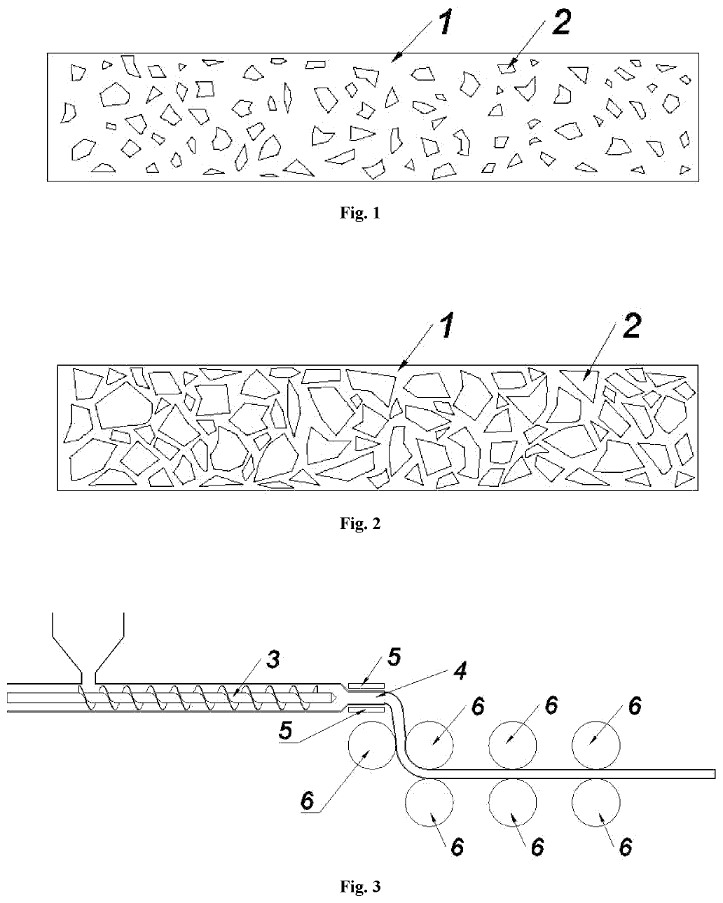

As shown in FIG. 1, the WPC material manufactured by the well-known prior art, includes the base material of thermoplastics 1 surrounding the reinforcing materials 2 which are wood beads sized about 2-3 mm, compressed with high pressure in the cylinder in the production process of the WPC materials, thereby reducing original sizes of wood beads to 1-1.5 mm, then extruded with high pressure, thus the original density of 600-800 kg/m³ (original density of wood) is increased to 1100-1500 kg/m³. With specific density of thermoplastics of about 950 kg/m³, ratio of thermoplastics and wood of about 50%-50% then the obtained density of WPC is about 1100-1400 kg/m³.

As shown in FIG. 2, the WPC material manufactured by the low-pressure extrusion method according to present disclosure includes the matrix materials of thermoplastics 1 surrounding the reinforcing materials 2 which are wood beads sized about 2-3 mm, with wood-plastic ratio similar to that of the WPC material in the FIG. 1. In the production process using the low-pressure extrusion method, the shape of the wood beads, not compressed with as high pressure as in the prior art, namely lower than 300-500 kg/cm², may remain the same, thus preserve the original density of 600-800 kg/m³ (or inconsiderably increased). With specific density of thermoplastics of about 950 kg/m³, ratio of thermoplastics and wood of about 50%-50% then the obtained density of WPC is less than 1000 kg/m³, which may be up to 775-875 kg/m³, meanwhile the specific density of conventional WPC always remains at about 1100-1400 kg/cm³.

As discussed above, with any ratio of thermoplastics and wood (commonly 30%-70% thermoplastics-wood to 70%-30% thermoplastics-wood) the density of the WPC manufactured by the low pressure extrusion method is always lower than the density of 1100-1400 kg/m3 of the WPC manufactured by conventional method with the same ratio of thermoplastics-wood, except that the conventional WPC uses PVC with the foaming method using foaming agents and particular mold structures to form empty air bubbles within the WPC material block. Depending on the material type, density of the wood-based composite material according to present is about 775-875 kg/m³.

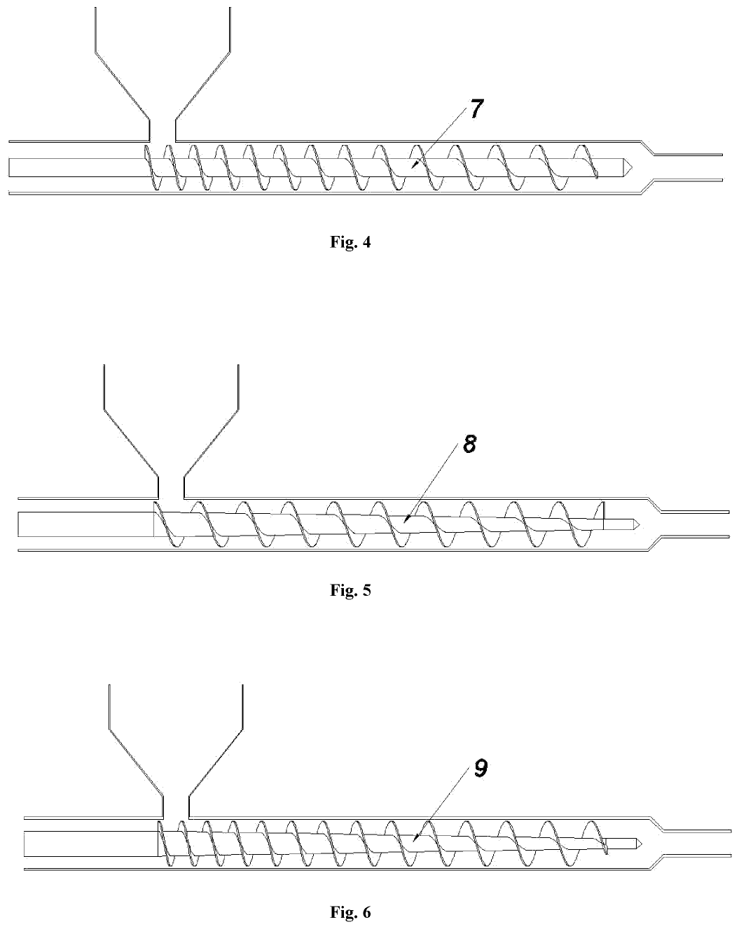

As shown in FIG. 3, the low pressure extruder to produce the low density plastic composite material includes cylinder 7 provided with the heater 5 for the die 4, the hopper 8 to supply the materials into the cylinder, the die 4 to release the materials from the cylinder, the screw 9 to mix composition of the composite material into a mixture in melted state within the cylinder of the extruder and to constantly extrude the mixture through the die.

The volume between the cylinder and the screw per unit length is not decreased along the direction from the hopper 8 to the die in order that the mixture is extruded at low pressure in the melted state out of the cylinder of the extruder.

The die 4 is heated by the heater 5 to maintain the melted state of the material in order not to form resistance to the flow in the process of extruding the material mixture out of the cylinder of the extruder.

In various embodiments, the reinforcing material may be wood beads, wood chips, vegetal fibers, fiberglass, fabric fibers, chaff, fabric scraps or the like.

In an alternative embodiment, the reinforcing material is pellets pre-formed with the pelletizing granulation extrusion technology, wherein loose materials such as wood beads, wood chips, vegetal fibers, fiberglass, fabric fibers, chaff, fabric scraps or the like are ground into beads sized 0.5-5 mm, the thermoplastics and additives are mixed in melted state before being shaped into strings with diameter of 1-5 mm in an extrusion die, then cooled and cut into beads sized 1-15 mm. With this reinforcing material, density of the obtained plastic composite material is low, depending on specific materials, but generally lower than 1000 kg/m³.

In another aspect, the invention provides a method for manufacturing the low-density WPC material. The method for manufacturing the low-density WPC materials is discussed in further detail below.

Referring to FIG. 3, the low-density plastic-wood composite material is formed by the method wherein wood (pulverized or ground with larger size depending on characteristics of the extruder and products), thermoplastics and additives are mixed in melted state within the cylinder of the extruder with screw 7, constant screw pitch, and constant groove depth. This configuration of the screw is different from that of the screw in the conventional WPC manufacturing method, wherein it creates a constant volume of the material mixture during the flowing along the cylinder of the extruder from the hopper to the extrusion mold in order not to form high pressure in the material mixture. Another difference compared to conventional methods is, instead of being cooled and shaped by an extrusion die with low temperature, the material mixture according to the present disclosure is released from the extruder through a die 4 heated by the heaters 5 to maintain its melted state in order not to form resistance to the flow in the process of extruding the material mixture out of the cylinder of the extruder.

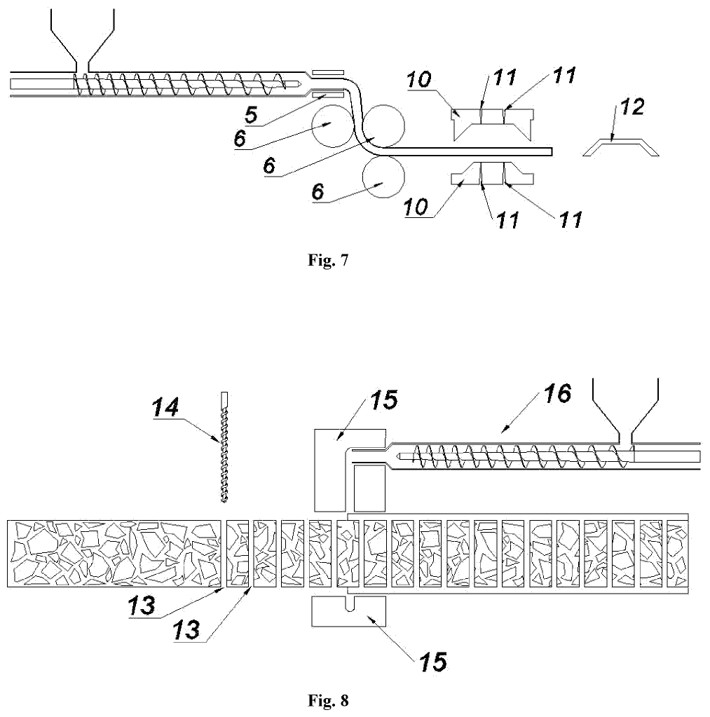

In an aspect, as shown in FIG. 3 and FIG. 7, the invention provides the equipment for producing the low-density plastic composite materials comprising the low-pressure extruder 3, wherein the equipment further includes cooling and shaping structure, which in an embodiment in the drawings are shaping rollers 6 to produce the WPC material sheet. Because the shaping rollers 6 compress the WPC material in melted state, the WPC material freely overflow in horizontal and longitudinal directions to the roller and then it is cooled by the succeeding rollers without changing its size, thus its density is not considerably increased compared to the previous melted state.

In an alternative embodiment, also with the purpose of not increasing pressure on the wood in the material mixture, as shown in FIG. 4, the material mixture mixing process uses the extruder with screw 7 with ascending screw pitch, constant groove depth.

In an alternative embodiment, as shown in FIG. 5, the material mixture mixing process uses the extruder with screw 7 with constant screw pitch, ascending groove depth.

In an alternative embodiment, as shown in FIG. 6, the material mixture mixing process uses the extruder with screw 7 with ascending screw pitch, ascending groove depth.

FIG. 7 is a schematic view illustrating product manufacturing method using the low-density WPC materials in accordance with an embodiment, wherein the WPC material sheets, after being shaped and partially cooled by the shaping rollers 6, are shaped by a press die 10 with material discharge grooves 11. In this case the WPC material compressed and shaped in the press die 10 will have the shape of the final product 12 meanwhile the redundant material is extruded to the material discharge grooves 11. Such a process will not increase density of the WPC material.

In an embodiment, to enhance mechanical properties and bonding of the WPC constituents, the invention proposes producing the spine structure bound with thermoplastics (or other matrix materials) from the coating into the center of or throughout the WPC block. One of the methods for manufacturing the spine structure is as follows.

Referring to FIG. 8, the WPC material sheet, after being cooled and shaped by the rollers, is provided with through holes 13 by the hole maker 14 such as drill, for example. After that, the material sheet is put into the wrapping mold 15. The extruder 16 continuously supplies thermoplastics (or other matrix materials) in melted state through the wrapping mold 15 to form a coating over the entire material sheet, simultaneously filling up the previously formed through holes of the material sheet, forming the binding spine structure for the WPC material sheet. Due to the binding properties of constituents of the thermoplastics (or other matrix materials) the spine structure will accordingly have these WPC constituents' mechanical properties and binding increased.

In an aspect, the invention provides manufacturing method of the low-density plastic composite material, comprising:
feeding the constituent materials into the cylinder 9 via the hopper 8;
mixing the constituent materials into a mixture in melted state within the cylinder 9 of the extruder by the screw 7;
characterized by,
the mixture in melted state is continuously extruded at low pressure through the die 4 of the extruder due to the volume between the cylinder 9 and the screw 7 per unit length not being reduced, thus not creating high pressure;
the mixture is maintained in melted state by a heater 5 configured to heat the die 4 in order not to form resistance to the flow in the process of pushing the material mixture out of the cylinder 9 of the extruder.

In this description, aspects and embodiments of the present invention are described in relation with the objects of products, processes, and equipment. The present disclosure is described for the purpose of illustration of the objects and it should be understood that, to a person skilled in the art to which the present invention pertains, the features described for the extruder can be used to infer the equivalent features of implementation steps as well as the equivalent features of the products and vice versa.

Although the present invention is described by specific embodiments, it is obvious that various changes and modifications may be made by a person skilled in the art to which the present invention pertains. The scope of the present invention is limited only by the appended claims.

I claim:

1. A low-pressure extruder (3) for manufacturing a low-density plastic composite material, comprising:
a cylinder (9);
a hopper (8) to supply constituents of the composite material into the cylinder (9);
a screw (7) to mix the constituents of the composite material into a mixture in melted state within the cylinder (9) of the extruder and to continuously extrude this mixture;
a die (4) to release the mixture out of the cylinder;
a heater (5);
characterized by,
the volume between the cylinder (9) and the screw (7) per unit length is not decreased along the direction from the hopper (8) to the die (4) in order that the mixture is extruded at low pressure in the melted state out of the cylinder (9) of the extruder;
the heater (5) configured to heat the die (4) to maintain the melted state of the mixture in order not to form resistance to the flow in the process of pushing the material mixture out of the cylinder (9) of the extruder.

2. The extruder of claim 1, wherein the screw (7) has constant screw pitch, constant groove depth.

3. The extruder of claim 1, wherein the screw (7) has ascending screw pitch, constant groove depth.

4. The extruder of claim 1, wherein the screw (7) has constant screw pitch, ascending groove depth.

5. The extruder of claim 1, wherein the screw (7) has ascending screw pitch, ascending groove depth.

6. The equipment to produce a low-density plastic composite material, comprising an extruder (3) according to claim 1.

7. The equipment to produce a low-density plastic composite material of claim 6, wherein the equipment further includes cooling and shaping structure arranged after the extruder for cooling and shaping the material mixture after the extrusion.

8. The equipment to produce a low-density plastic composite material of claim 6, wherein the equipment further includes a press die (10) with material discharge grooves (11) arranged after the extruder (3) for shaping the material after the extrusion.

9. The equipment to produce a low-density plastic composite material of claim 8, wherein the equipment further includes a cooling and shaping structure arranged after the extruder and before the press die.

10. The equipment to produce a low-density plastic composite material of claim 7, wherein the cooling and shaping structure is the rollers (6).

11. The equipment to produce a low-density plastic composite material of claim 7, wherein the equipment further includes:
a hole maker (14) arranged after the rollers (6) to form through holes for the material after cooling and shaping;
a wrapping mold (15) arranged after the hole maker (14);
an extruder (16) to supply a melted matrix material into the wrapping mold (15);
wherein:
the wrapping mold (15) forms a coating and fills up through holes (13) of the material.

12. The manufacturing method of the low-density plastic composite material comprises:
feeding constituent materials into the cylinder (9) of the extruder via the hopper (8) of the extruder;
mixing the constituent materials into a mixture in melted state within the cylinder (9) of the extruder by the screw (7) of the extruder;
characterized by,
the mixture in melted state is continuously extruded at low pressure through the die (4) of the extruder due to the volume between the cylinder (9) and the screw (7) per unit length not being reduced, thus not creating high pressure;
the mixture is maintained in melted state by a heater (5) configured to heat the die (4) in order not to form resistance to the flow in the process of pushing the material mixture out of the cylinder (9) of the extruder.

13. The manufacturing method of the low-density plastic composite material of claim 12, wherein the method further includes cooling and shaping the mixture extruded from the die (4) by the cooling and shaping structure arranged after the die (4).

14. The manufacturing method of the low-density plastic composite material of claim 12, wherein the method further includes shaping the mixture into the product by the press die (10) with material discharge grooves (11).

15. The manufacturing method of the low-density plastic composite material of claim 14, wherein the method further includes cooling and shaping the mixture extruded from the die (4) by the cooling and shaping structure (6) arranged after the extruder (3) before being shaped by the press die (10).

16. The manufacturing method of the low-density plastic composite material of claim 13, wherein the cooling and shaping structure (6) is the rollers.

17. The manufacturing method of claim 13, the method further includes:
forming through holes (13) for the material after cooling and shaping;
wrapping to form a coating and fill up the through holes (13) for the material.

18. The method according to claim 12, wherein composition of the composite material includes at least one type selected from the group including wood beads, wood chips, vegetal fibers, fiberglass, fabric fibers, chaff, fabric scraps or the like.

19. The method according to claim 12, wherein composition of the composite material includes material beads pre-formed with the pelletizing granulation extrusion technology according to the following method:
mixing loose materials such as wood beads, wood chips, vegetal fibers, fiberglass, fabric fibers, chaff, fabric scraps or the like are ground into beads sized 0.5-5 mm, the thermoplastics and additives into a mixture in melted state before shaping the mixture into strings with diameter of 1-5 mm in a continuous casting mold, then cooling and cutting into beads sized 1-15 mm.

20. The low-density plastic composite material manufactured by the method of claim 12, characterized by, this material comprises reinforcing material and other plastic than PVC, in solid form, proportion of the reinforcing material is in the range of 20-80%, density of less than 1000 kg/m³.
